(19) United States
(12) Patent Application Publication
(10) Pub. No.: US 2009/0146333 A1
(43) Pub. Date: Jun. 11, 2009

(54) APPARATUS AND METHOD FOR CONTROLLING MOLD TEMPERATURES

(75) Inventors: TANG-LIN LIN, Tu-Cheng (TW); SHU-MING LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/056,241

(22) Filed: Mar. 26, 2008

(30) Foreign Application Priority Data
Dec. 11, 2007 (CN) 200710202984.1

(51) Int. Cl. B29C 45/78

(52) U.S. Cl. 264/40.6

(57) ABSTRACT

An apparatus for controlling temperatures of a mold includes a first heating system, a second heating system, and a cooling system. The first heating system is used for pre-heating medium therein. The second heating system is used for further heating the pre-heated medium provided by the first heating system, and providing the heated medium for the mold after draining out preexisting leftover medium in the mold, before injection molding. The cooling system is used for cooling down the mold after injection molding. A relative method for controlling temperatures of the mold is provided as well.

### BACKGROUND

1. Field of the Invention

The present invention generally relates to apparatuses and methods for controlling temperatures. Particularly, the present invention relates to an apparatus and a method for controlling temperatures of molds for plastics.

2. Description of Related Art

Plastics are mainly manufactured by injection molding. Molten resin is injected into molds to form plastic products with predetermined shapes. During injection molding, pressures, velocities, and temperatures are precisely controlled, so that quality plastic products are produced.

During steps of injection molding, the temperatures of the molds are controlled to be different. During mass production, the temperatures of the molds should be rapidly shifted, therefore, the cycle time of a product is shortened, and productivity improved.

### SUMMARY

In one embodiment, an apparatus for controlling temperatures of a mold includes a first heating system, a second heating system, and a cooling system. The first heating system is used for pre-heating medium therein. The second heating system is used for further heating the pre-heated medium provided by the first heating system, and providing the heated medium to the mold after preexisting leftover medium is drained from the mold, before injection molding. The cooling system is used for cooling down the mold after injection molding.

Other advantages and novel features of the apparatus and method for controlling temperature of a mold will become more apparent from the following detailed description of embodiments when taken in conjunction with the accompanying drawings, in which:

### BRIEF DESCRIPTION OF THE DRAWINGS

FIG. 1 is a schematic diagram of an apparatus for controlling mold temperatures in accordance with an exemplary embodiment;

FIG. 2 is a schematic diagram of the apparatus of FIG. 1 in a first working state, the arrows showing direction that medium flows in the apparatus;

FIG. 3 is a schematic diagram of the apparatus of FIG. 1 in a second working state;

FIG. 4 is a schematic diagram of the apparatus of FIG. 1 in a third working state;

FIG. 5 is a schematic diagram of the apparatus of FIG. 1 in a fourth working state;

FIG. 6 shows a time sequence of on/off states of valves in the apparatus of FIG. 1; and

FIG. 7 is a flow chart of a method for controlling mold temperatures in accordance with an exemplary embodiment.

### DETAILED DESCRIPTION

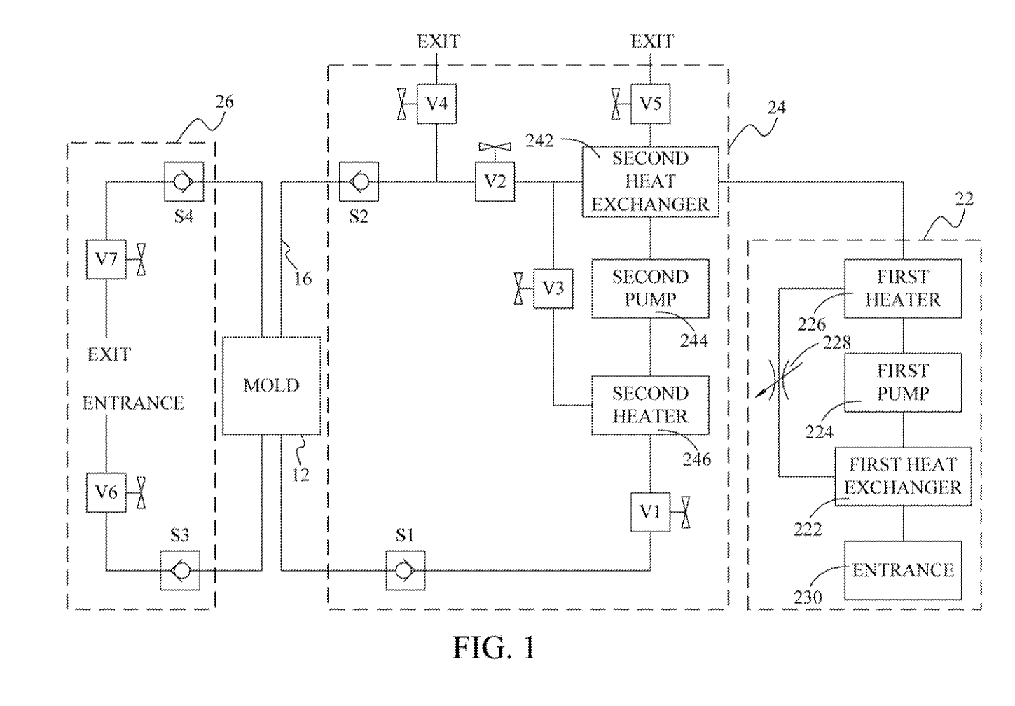

Referring to FIG. 1, an apparatus for controlling mold temperatures in accordance with an exemplary embodiment is incorporated in a molding apparatus for controlling the temperatures of a mold 12. The apparatus is connected with the mold 12 through tubes 16, and controls the temperatures of the mold 12 through medium flowing in the tubes 16, therefore heating or cooling the mold 12. In the embodiment, the medium flowing in the tubes 16 is water.

The apparatus includes a first heating system 22, a second heating system 24, and a cooling system 26. The first and second heating systems 22, 24 are used for heating the medium and sending the medium into the mold 12 to heat the mold 12 before injection molding. The cooling system 26 is used for cooling down the mold 12 after injection molding.

The first heating system 22 includes a first heat exchanger 222, a first pump 224, a first heater 226, and a throttle 228. The first heat exchanger 222 is connected to a cold medium entrance 230, for exchanging heat between the cold medium that has entered through the medium entrance 230 to heat the medium in the first heating system 22. The first heat exchanger 222 is also connected to a cold medium exit through a valve (not shown). The first pump 224 is used for pumping the medium into the first heater 226 from the first heat exchanger 222. Therefore the cold medium is pre-heated by the first heater 226. The pre-heated medium is sent into the second heating system 24, or fed back into the first heat exchanger 222 through the throttle 228. The first heat exchanger 222, the first pump 224, and the first heater 226 form a loop through the throttle 228.

The second heating system 24 is used for heating the medium provided by the first heating system 22, and sending the heated medium to the mold 12, thereby heating the mold 12. The second heating system 24 includes a second heat exchanger 242, a second pump 244, and a second heater 246, whose working principle is generally the same as that of the first heating system 22, but at a higher temperature.

The second heating system 24 further includes first through fifth valves V1˜V5, a first check valve S1, and a second check valve S2. In the embodiment, the valves V1˜V5 are electromagnetic valves. The first check valve S1 is set to allow medium to flow only from the second heating system 24 into the mold 12, and the second check valve S2 is set to allow medium to flow only from the mold 12 into the second heating system 24. The second heating system 24 provides medium for the mold 12 through the second heat exchanger 242, the second pump 244, the second heater 246, the first valve V1, and the first check valve S1, that are connected by tubes in series. After the medium has heated up the mold 12 and pumped the medium out from the mold 12, the medium flows through the second check valve S2, the second valve V2 to exchange heat in the second heat exchanger 242.

One end of the third valve V3 is connected between the second valve V2 and the second heat exchanger 242, the other end of the third valve V3 is connected to the second heater 246. Therefore, the second heat exchanger 242, the second pump 244, and the second heater 246 form a loop through the third valve V3, for heating the medium therein. One end of the fourth valve V4 is connected between the second check valve S2 and the second valve V2, the other end of the fourth valve V4 is connected to a cold medium exit. Two ends of the fifth valve V5 are respectively connected to the second heat exchanger 242 and a cold medium exit.

The cooling system 26 includes a sixth valve V6, a seventh valve V7, a third check valve S3, and a fourth check valve S4. The third check valve S3 is set to allow medium to flow only from the cooling system 26 into the mold 12, and the fourth check valve S4 is set to allow medium to flow only from the mold 12 into the cooling system 26. One end of the sixth valve V6 is connected to a cold medium exit, the other end of the sixth valve V6 is connected to the mold 12 through the third check valve S3, for sending cold medium to the mold 12. One end of the seventh valve V7 is connected to a cold medium exit, the other end of the seventh valve V7 is connected to the mold 12 through the fourth check valve S4, for draining the medium from the mold 12.

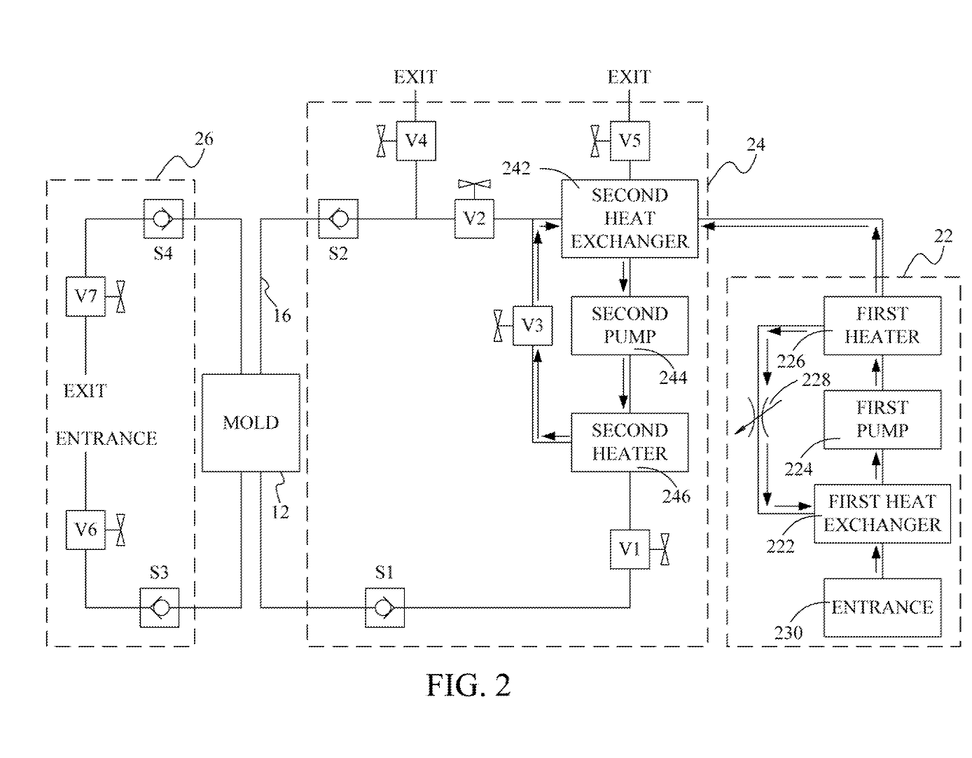

Referring to FIG. 2, after the apparatus is powered on, the first heating system 22 begins to work. The cold medium is infused into the first heating system 22 through the cold medium entrance 230 and heated by the first heating system 22. The medium heated by the first heating system 22 is infused into the second heating system 24. The first valve V1, the second valve V2, and the fourth valve V4 are closed, the third valve V3 is opened. Therefore, the medium provided by the first heating system 22 is further heated in the loop formed by the second heat exchanger 242, the second pump 244, and the second heater 246 through the third valve V3.

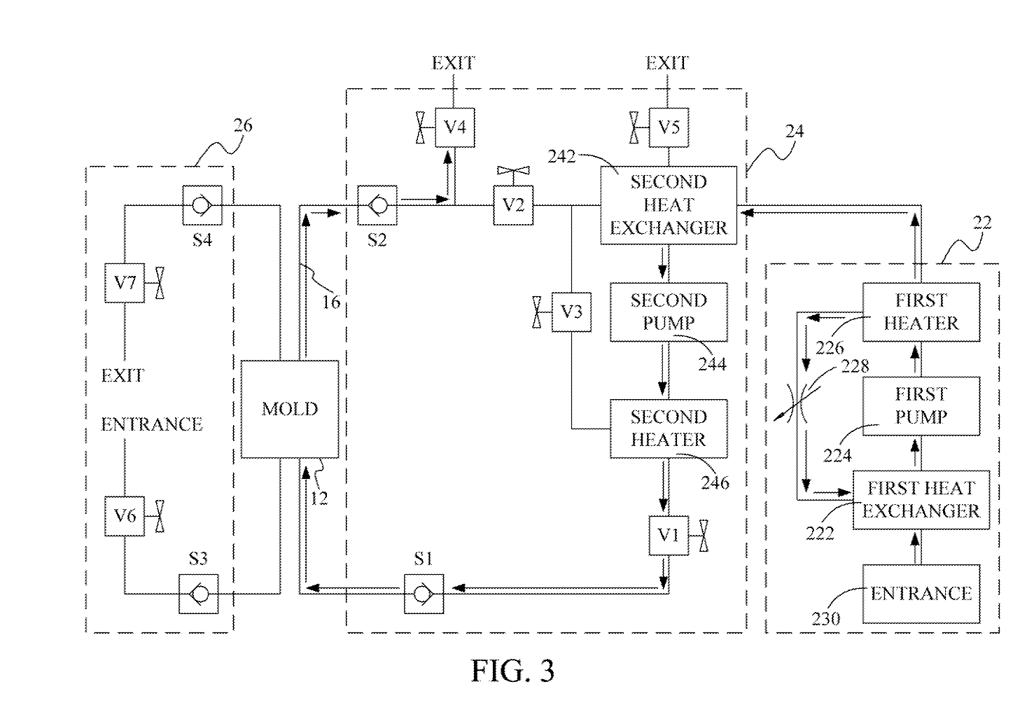

Referring to FIG. 3, before injection molding, the mold 12 should be heated up. The first valve V1 is opened, and the third valve V3 is closed. Therefore, the medium heated by the second heating system 24 flows into the mold 12 through the valve V1 and the first check valve S2. Meanwhile, the fourth valve V4 stays open for a predetermined time. Therefore, the leftover medium in the mold 12 is drained out through the second check valve S2 and the fourth valve V4. The predetermined time depends on the speed that the medium is drained out of the mold 12. For example, in this embodiment the predetermined time is 2 seconds.

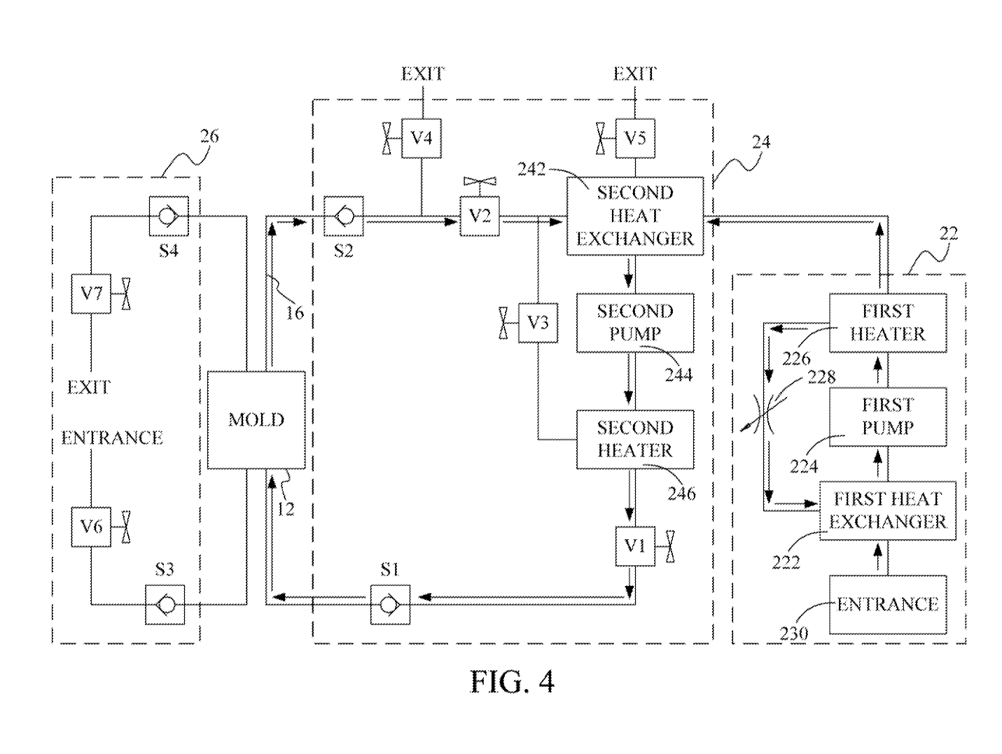

Referring to FIG. 4, after the predetermined time, the fourth valve V4 is closed, while the second valve V2 is opened to allow the medium in the mold 12 to feed back to the second heater 246 of the second heating system 24 through the second check valve S2.

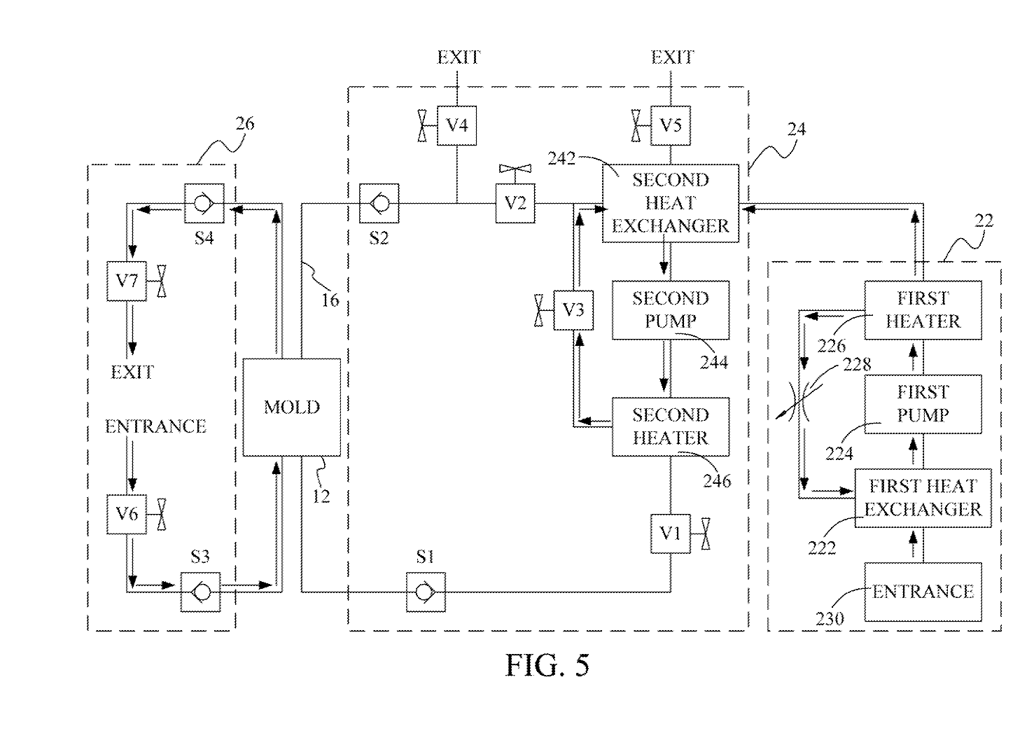

Referring to FIG. 5, after injection molding, the mold 12 needs to be cooled down. The first valve V1, the second valve V2 and the fourth valve V4 are closed, and the third valve V3 is opened. Therefore, the medium flowing in the second heating system 24 cannot go into the mold 12, but instead is continuously heated in the loop formed by the second heat exchanger 242, the second pump 244, and the second heater 246 through the third valve V3. The sixth valve V6 and the seventh valve V7 of the cooling system 26 are opened to allow the cold medium to flow into the mold 12 through the third check valve S3, therefore the mold 12 is cooled down. After cooling down the mold 12, the medium is drained out of the mold 12 through the fourth check valve S4 and the seventh valve V7.

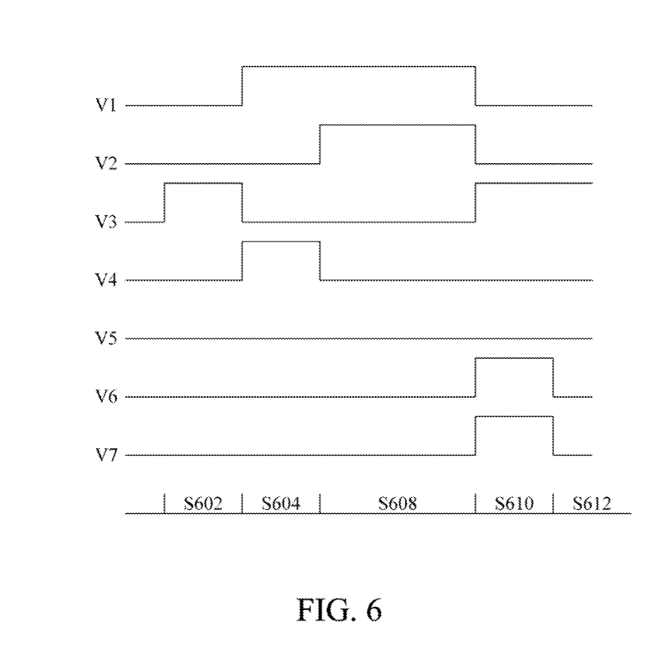

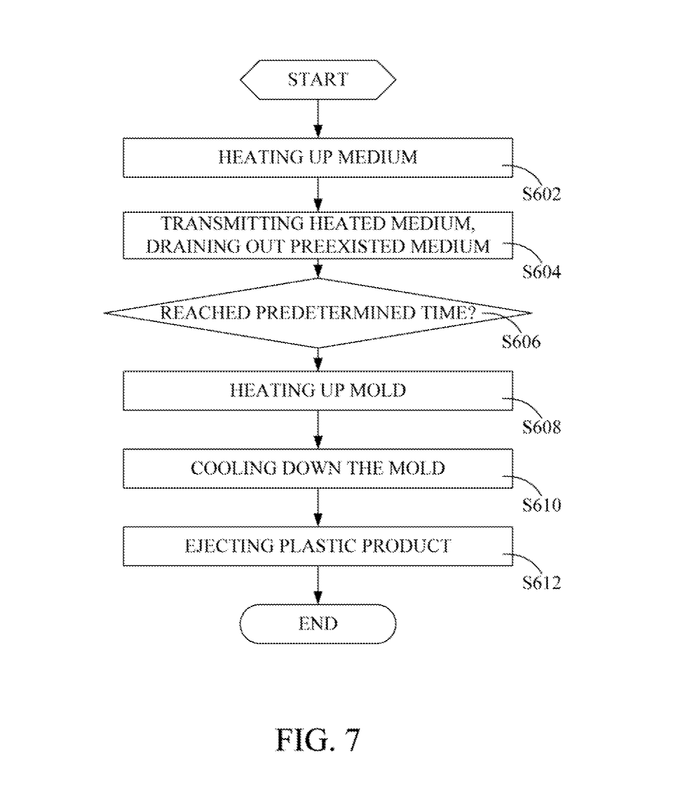

Referring to FIG. 6, a time sequence of open/closed states of each valve is illustrated. A flow chart of a method for controlling the mold temperatures is shown in FIG. 7 and is described in association with FIG. 6.

Step S602, after the apparatus is powered on, only the third valve V3 of the second heating system 24 is opened, and the other valves V1, V2, and V4-V7 are all closed. Therefore, the medium is continuously heated in the loop formed by the second heat exchanger 242, the second pump 244, and the second heater 246 through the third valve V3.

Step S604, before injection molding, the third valve V3 is closed, the first valve V1 is opened to allow the medium of the second heating system 24 to go into the mold 12, for heating the mold 12. Meanwhile, the fourth valve V4 is opened to allow the leftover medium in the mold 12 to be drained out. The fourth valve V4 stays open for a predetermined time.

Step S606, during the predetermined time, the medium of the mold 12 flows out through the second check valve S2 and the valve V4.

Step S608, after the predetermined time, the fourth valve V4 is closed, meanwhile the second valve V2 is opened. Therefore, the medium of the mold 12 is fed back into the second heat exchanger 242 of the second heating system 24 through the second check valve S2 and the second valve V2, and again sent into the mold 12 through the first valve V1 and the first check valve S1 after being heated by the second heater 246 again.

Step S610, after injection molding, the first, second valves V1 and V2 are closed, and the third valve V3, the sixth valve V6, and the seventh valve V7 are open. Therefore, the cold medium enters the mold 12 through the cold medium entrance, the sixth valve V6, and the third check valve S3. After cooling down the mold 12, the medium is drained out of the mold 12 through the fourth check valve S4 and the seventh valve V7.

Step S612, after the plastic product is ejected from the mold 12, the sixth and seventh valves V6 and V7 are closed, therefore preventing the cold medium from entering the mold 12. Then step S604 goes on to heat the medium for a next cycle.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. An apparatus for controlling temperatures of a mold, comprising:
a first heating system for pre-heating medium therein;
a second heating system for further heating the pre-heated medium provided by the first heating system, and sending the heated medium to the mold after draining out preexisted leftover medium in the mold, before injection molding; and
a cooling system for cooling down the mold after injection molding.

2. The apparatus as describe in claim 1, wherein the first heating system comprises a heat exchanger, a pump, and a heater that are connected in series through tubes, the medium is pre-heated in a loop formed by the heat exchanger, the pump, and the heater.

3. The apparatus as described in claim 1, wherein the second heating system comprises a heat exchanger, a pump, and a heater that are connected in series through tubes, the pre-heated medium provided by the first heating system is further heated up in a loop formed by the heat exchanger, the pump, and the heater.

4. The apparatus as described in claim 3, wherein the second heating system further comprises a first valve through which the heated medium from the loop is transmitted into the mold, and a second valve through which medium after heating the mold is fed back into the loop.

5. The apparatus as described in claim 4, wherein the second heating system still further comprises a third valve, one end of the third valve is connected to the heater, the other end of the valve is connected between the second valve and the heat exchanger, for allowing the medium to flow in the loop to be heated as the first and second valves are closed.

6. The apparatus as described in claim 4, wherein the second heating system still further comprises a third valve, one end of the third valve is connected between the mold and the second valve, the other end of the third valve is connected to a cold medium exit, for draining out the preexisting leftover medium in the mold.

7. The apparatus as described in claim 6, wherein the third valve keeps switching on for a predetermined time to drain out the preexisting leftover medium in the mold.

8. The apparatus as described in claim 7, wherein the predetermined time is 2 seconds.

9. The apparatus as described in claim 4, wherein the second heating system further comprises a check valve connected between the first valve and the mold, for allowing medium to flow only from the second heating system into the mold.

10. The apparatus as described in claim 4, wherein the second heating system further comprises a check valve connected between the mold and the second valve, for allowing medium to flow only from the mold into the second heating system.

11. A method for controlling temperatures of a mold, comprising steps of:
heating medium;
providing the heated medium for the mold;
draining out preexisting leftover medium in the mold; and
heating the mold via the heated medium.

12. The method as described in claim 11, the step of heating medium comprising:
pre-heating the medium in a first heating system; and
providing the pre-heated medium for a second heating system for further heating.

13. The method as described in claim 12, the step of providing the preliminarily heated medium for a second heating system for further heating comprising:
cutting off connections between the second heating system and the mold; and
switching on a valve in a loop formed by a heat exchanger, a pump, a heater, and the valve, of the second heating system, to further heating the medium.

14. The method as described in claim 12, the step of draining out preexisting leftover medium in the mold comprising:
switching on a valve connected between a cold medium entrance and the mold;
draining out the preexisting leftover medium in the mold through the valve;
keeping the valve switching on for a predetermined time; and
switching off the valve after the predetermined time.

15. The method as described in claim 14, wherein the predetermined time is 2 seconds.

16. The method as described in claim 12, further comprising:
cutting off connections between the second heating system and the mold after injection molding;
allowing cold medium to be transmitted into the mold;
cooling down the mold; and
draining the cold medium out of the mold.
